(19) United States
(12) Patent Application Publication
(10) Pub. No.: US 2020/0311746 A1
(43) Pub. Date: Oct. 1, 2020

(54) METHOD AND SYSTEM FOR LEVERAGING IN-STORE IOT DATA

(71) Applicant: MASTERCARD INTERNATIONAL INCORPORATED, Purchase, NY (US)

(72) Inventors: Kamal Kishore Parida, Dubai (AE); Vibhav Prasad, Rye Brook, NY (US); Curtis C. Villars, Chatham, NJ (US)

(73) Assignee: MASTERCARD INTERNATIONAL INCORPORATED, Purchase, NY (US)

(21) Appl. No.: 16/369,732

(22) Filed: Mar. 29, 2019

(51) Int. Cl. G06Q 30/02; G06Q 20/08; G06Q 20/20; H04L 29/08

(52) U.S. Cl. CPC G06Q 30/0201; H04L 67/22; G06Q 20/204; G06Q 20/085

(57) ABSTRACT

A method for providing analytics for a physical customer based on processed remote transactions includes: storing transaction data entries, each including a time, date, additional value, and data; receiving a notification including a detection time, detection date, and identification value; identifying a first transaction data entry where the date matches the detection date, the additional value matches the identification value, and the time is within a predetermined period of the detection time; identifying a subset of transaction data entries related to the first transaction data entry based on a correspondence in at least one of: the additional value and the transaction data included in the first transaction data entry and each entry in the subset; determining analytics based on the transaction data included in the subset; and transmitting the analytics to a third party device.

### FIELD

The present disclosure relates to the leveraging of data captured by internet of things (IOT) devices in a store for enrichment thereof with transactional data, specifically the use of analysis of transaction history to enrich in-store IOT data with information regarding purchases made out-of-store by in-store visitors.

### BACKGROUND

For merchants with physical storefronts, data regarding the spending habits and histories of their customers can be as valuable as the customers themselves. Merchants will often try to capture every bit of appropriately relevant data that they can about their customers: how often they visit, how long they visit for, how much they spend, and what products that they purchase. In more recent times, various devices have been used to provide even more data about consumers that visit a physical storefront, such as recording the number of consumers that enter and exit the premises, the frequency of visits, the length of time consumers stay in the store and in what locations of the store, the paths consumers take while visiting, where consumers linger while shopping, etc.

While this information can be valuable, it is limited to actions and behaviors of consumers that physically visit the storefront and while they are actually at the store. As a result, the merchant receives an incomplete picture of the consumer's transaction behavior, and may be missing beneficial information that may help them identify their most valuable consumers and develop new ones. For instance, a merchant may have a consumer that visits their storefront once every two weeks, which the merchant may assume to be a strong, loyal customer, when, in reality, that consumer may visit a competitor more often and spend more. Such information is unavailable to merchants unless provided directly by consumers themselves. This is due to the technical problem of detecting and recording information when the merchant has no appropriate access to a different merchant's physical location or data.

Thus, there is a need for a technological solution to enrich data gathered by merchants regarding physical customers with transactional behavior that is not limited to transactions involving that merchant that does not require access to a different merchant's location or data but nevertheless provides the equivalent data value.

### SUMMARY

The present disclosure provides a description of systems and methods for providing analytics for a physical customer based on processed remote transactions. A merchant may gather information regarding a customer visiting their physical storefront through any manner of IOT devices. As part of the customer's visit, the customer may engage in a payment transaction for the purchase of one or more products from the merchant. A timestamp of the transaction may be captured by the merchant and provided to a processing server. The server may receive transaction data for payment transactions involving the merchant and a plurality of different merchants. The processing server may, using the provided timestamp, identify a corresponding transaction in its transaction data. The processing server may then identify related transactions, such as other transactions conducted by similar (e.g., based on demographic characteristics or account spending characteristics) consumers. The processing server may identify analytics using the identified transactions and provide the analytics back to the merchant. The analytics may include, for instance, spending habits at the merchant and other merchants, transaction frequencies, average transaction amounts, etc. The merchant may then use the analytics to enrich its own IOT data to better understand its customers.

A method for providing analytics for a physical customer based on processed remote transactions includes: storing, in a memory of a processing server, a plurality of transaction data entries, wherein each transaction data entry is related to a processed, remote payment transaction and includes at least a transaction time, transaction date, additional data value, and transaction data; receiving, by a receiver of the processing server, a notification from a remote device, wherein the notification includes at least a detection time, a detection date, and an identification value; executing, by a processing device of the processing server, a first query on the memory of the processing server to identify a first transaction data entry of the plurality of transaction data entries where the transaction date matches the detection date, the additional value matches the identification value, and the transaction time is within a predetermined period of time of the detection time; executing, by the processing device of the processing server, a second query on the memory of the processing server to identify a subset of transaction data entries related to the first transaction data entry based on a correspondence in at least one of: the additional value and the transaction data included in the first transaction data entry and each of the transaction data entries in the subset; determining, by the processing device of the processing server, one or more analytics based on at least the transaction data included in each transaction data entry in the subset; and transmitting, by a transmitter of the processing server, the determined one or more analytics to a third party device.

A system for providing analytics for a physical customer based on processed remote transactions includes: a memory of a processing server configured to store a plurality of transaction data entries, wherein each transaction data entry is related to a processed, remote payment transaction and includes at least a transaction time, transaction date, additional data value, and transaction data; a receiver of the processing server configured to receive a notification from a remote device, wherein the notification includes at least a detection time, a detection date, and an identification value; a processing device of the processing server configured to execute a first query on the memory of the processing server to identify a first transaction data entry of the plurality of transaction data entries where the transaction date matches the detection date, the additional value matches the identification value, and the transaction time is within a predetermined period of time of the detection time, execute a second query on the memory of the processing server to identify a subset of transaction data entries related to the first transaction data entry based on a correspondence in at least one of: the additional value and the transaction data included in the first transaction data entry and each of the transaction data entries in the subset, and determine one or more analytics based on at least the transaction data included in each transaction data entry in the subset; and a transmitter of the processing server configured to transmit the determined one or more analytics to a third party device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for enriching IOT data with transaction data in accordance with exemplary embodiments.

FIG. 2 is a block diagram illustrating the processing server of the system of FIG. 1 for providing analytics to enrich in-store IOT data in accordance with exemplary embodiments.

FIG. 3 is a flow diagram illustrating a process for the enrichment of in-store IOT data with additional transaction data in the system of FIG. 1 in accordance with exemplary embodiments.

FIG. 4 is a flow chart illustrating an exemplary method for providing analytics for a physical customer based on processed remote transactions in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 102 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

Microsegment—A representation of a group of consumers that is granular enough to be valuable to advertisers, marketers, offer providers, merchants, retailers, etc., but still maintain a high level of consumer privacy without the use or obtaining of personally identifiable information. Microsegments may be given a minimum or a maximum size. A minimum size of a microsegment would be at a minimum large enough so that no entity could be personally identifiable, but small enough to provide the granularity needed in a particular circumstance. Microsegments may be defined based on geographical or demographical information, such as age, gender, income, marital status, postal code, income, spending propensity, familial status, etc., behavioral variables, or any other suitable type of data, such as discussed herein. The granularity of a microsegment may be such that behaviors or data attributed to members of a microsegment may be similarly attributable or otherwise applied to consumers having similar characteristics. In some instances, microsegments may be grouped into an audience. An audience may be any grouping of microsegments, such as microsegments having a common data value, microsegments encompassing a plurality of predefined data values, etc. In some instances, the size of a microsegment may be dependent on the application. An audience based on a plurality of microsegments, for instance, might have ten thousand entities, but the microsegments would be aggregated when forming the audience and would not be discernible to anyone having access to an audience. Additional detail regarding microsegments and audiences may be found in U.S. patent application Ser. No. 13/437,987, entitled “Protecting Privacy in Audience Creation,” by Curtis Villars et al., filed on Apr. 3, 2012, which is herein incorporated by reference in its entirety.

System for Enriching in-Store IOT Data with Additional Transaction Data

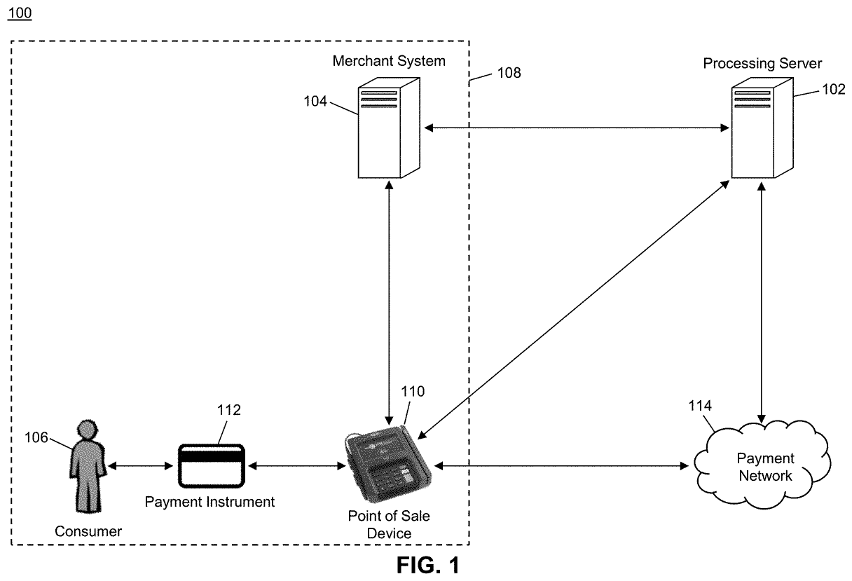

FIG. 1 illustrates a system 100 for the enrichment of IOT data captured regarding in-store activities by physical customers for a merchant with transaction data for processed, remote transactions that may involve additional merchants.

The system 100 may include a processing server 102. The processing server 102, discussed in more detail below, may be configured to enrich IOT data captured regarding in-store behavior of customers for a merchant, represented in FIG. 1 by the merchant system 104. The merchant system 104 may have a physical storefront, represented by the merchant area 108 in the system 100 illustrated in FIG. 1. The merchant system 104 may have a plurality of consumers 106 visit the merchant area 108 to shop. The merchant system 104 may use various IOT devices to track the movement and behavior of consumers 106 in the merchant area 108. IOT devices may include sensors, motion detectors, cameras, microphones, and point of sale devices 110, where the point of sale devices 110 may also be used to conduct payment transactions for the purchase of goods or services by the consumer 106 from the merchant system 104. As discussed herein, actions performed by the point of sale device 110 may be performed by any suitable IOT device used by the merchant system 104.

The merchant system 104 may, using the point of sale device 110 and other IOT devices, gather in-store IOT data on consumers 106 that visit the merchant area 108. The in-store IOT data may include, for instance, the number of visitors, frequency of visiting, visit lengths, time spent in specific areas of the merchant area 108, number of transactions, transaction amounts, frequency of transactions, rate of conversion, travel paths, number of guests in a party, etc. The merchant system 104 may store the gathered in-store IOT data, which may include general data regarding consumers 106 of the merchant system 104, and/or, in some instances, may include data regarding specific consumers 106. For example, a consumer 106 may register with the merchant system 104 for a loyalty account and provide permission for the merchant system 104 to track information regarding that consumer's visits with the merchant system 104.

The merchant system 104 may have a desire to enrich its in-store IOT data to identify how its consumers 106 are spending their money at other merchants. For instance, the merchant system 104 may be unaware of what kind of market share it has with its consumers 106 or what consumers may by beneficial for additional advertising or offers. The merchant system 104 may then turn to the processing server 102 to enrich its data.

The processing server 102 may be configured to gather transaction data regarding payment transactions involving the merchant system 104 and a plurality of additional merchants. The transaction data may be gathered by a payment network 114 as part of the processing of payment transactions thereby, where the transactions may be provided to the processing server 102. In some cases, the processing server 102 may be a part of the payment network 114 and may gather transaction data as part of the processing of payment transactions by the payment network 114. Transaction data gathered by the processing server 102 may include transaction times, transaction dates, transaction amounts, currency types, merchant identifiers, product data, offer data, loyalty data, reward data, acquirer data, issuer data, etc. for each transaction. In some cases, the transaction data captured by the processing server 102 may not contain any personally identifiable information (PII) or may be scrubbed of all PII before storage and use by the processing server 102. In other cases, transaction data may only include PII if explicitly approved by the associated consumer 106.

When the merchant system 104 wants to have data regarding a consumer 106 enriched, the merchant system 104 may provide a notification to the processing server 102 of a new payment transaction conducted in the merchant area 108. The consumer 106 may initiate a payment transaction with the merchant by providing a payment instrument 112 to a point of sale device 110 of the merchant system 104. The payment instrument 112 may be a credit card, debit card, check, or any other type of instrument that may be suitable to convey payment credentials associated with a transaction account that may be used to fund the payment transaction. The point of sale device 110 may receive the payment credentials from the payment instrument 112 and may initiate processing of the payment transaction by the payment network 114 using a suitable method and system (e.g., with participation by an issuer, acquirer, gateway processor, etc. using transaction messages formatted via suitable standards, such as the International Organization of Standardization's IOS 8583 or ISO 20022 standards).

The point of sale device 110 or other IOT device of the merchant system 104 may transmit the notification to the processing server 102. The notification may include at least a time and date of the payment transaction initiated by the consumer 106. In some embodiments, the point of sale device 110 may provide additional identifying information regarding the transaction and/or the consumer 106, such as a reference number for the transaction used by the merchant system 104, an identifier associated with the consumer 106 used by the merchant system 104, a primary account number read from the payment instrument 112, a point of sale identifier associated with the point of sale device 110, etc. In some instances, the notification may include the in-store IOT data captured by the merchant system 104.

The processing server 102 may receive the notification and may use the data included therein to identify the payment transaction involving the consumer 106. The processing server 102 may use fuzzy logic and inferred matching to match a processed payment transaction for which the processing server 102 has received data to the notification received from the point of sale device 110. For instance, the processing server 102 may identify all transactions conducted on the same day using the date included in the notification and the transaction date for each payment transaction, and then identify the exact payment transaction using the transaction time. For example, the processing server 102 may look for payment transactions where the transaction time is within a predetermined period of time of the time included in the notification. The predetermined period of time may be based on the average processing time for payment transactions, transmission times from the point of sale device 110, etc. The predetermined period of time may be, for example, three minutes. In cases where the notification includes additional data, the additional data may be used to help identify the transaction. For instance, if the notification includes (or the processing server 102 otherwise has access to) the merchant identifier associated with the merchant system 104, the processing server 102 may identify a processed payment transaction for the same time and date that involved the merchant system 104 using the merchant identifier.

Once the payment transaction has been identified, the processing server 102 may identify one or more analytics. The analytics may be identified using the payment transaction and other payment transactions related thereto. In embodiments where the consumer 106 has approved the use of their transaction data, the related payment transaction may include or be comprised of other payment transactions involving the consumer 106, such as may be identified using a primary account number found in the identified payment transaction. In other embodiments, the related payment transactions may include payment transactions involving consumers similar to the consumer 106. Similar consumers may be consumers that have matching or similar demographic characteristics and/or matching or similar transaction behaviors based on past transaction histories.

For example, the processing server 102 may identify the payment transaction and then identify a microsegment that includes the transaction account used in the payment transaction (e.g., which may be identified through the primary account number, which may be hashed or otherwise obscured from being PII, or other suitable data). The microsegment may include a handful of consumers that includes the consumer 106 or may include consumers similar or the same as the consumer 106 in terms of demographic characteristics. The processing server 102 may then identify, as related payment transactions, any payment transactions involving the consumers in the microsegment. In another example, a microsegment may include a plurality of consumers whose transaction behavior may be similar or the same from one another, as may be determined by the processing server 102 using their respective transaction histories (e.g., which may be identified and analyzed without the use of PII).

Once related payment transactions have been identified, the processing server 102 may identify one or more analytics using the transaction data for the identified and related payment transactions. In some cases, the notification transmitted by the point of sale device 110 may specify the one or more analytics to be identified. In other cases, the merchant system 104 may transmit a request (e.g., accompanying the notification or separate therefrom) that specifies analytics to be identified for notifications submitted by IOT devices of the merchant system 104. Analytics may include any kind of data that may be identified from transaction data that may be useful for a merchant. For instance, analytics may include number of transactions, average ticket amount, frequency of transactions, total spending amount, etc., which may be broken down by merchant, merchant category, day of the week, time of day, weather conditions, geographic area, etc. In an example, the merchant system 104 may request a comparison of the number of transactions at the merchant system 104 and the number of transactions at all other merchants and other merchants in the same industry (e.g., identified via merchant category code) as the merchant system 104, as well as the average ticket amount for such transactions.

After such analytics are identified, the processing server 102 may provide the analytics to the merchant. In some cases, the analytics may be provided to the point of sale device 110 or other IOT device as a response to the notification. In other cases, the analytics may be provided directly to the merchant system 104. Communications made by the processing server 102 and the point of sale device 110 and/or merchant system 104 may use any suitable communication network and method, such as via the Internet, a cellular communication network, payment rails associated with the payment network 114, etc.

The merchant system 104 may then use the analytics to enrich its in-store IOT data. For instance, the merchant system 104 may capture data regarding visit frequency and average visit length and ticket amounts for its consumers 106 that visit the merchant area 108, and then have that data enriched with transaction frequencies and average ticket amounts for other merchants in the same industry. The merchant system 104 can then use that information to determine what consumers 106 are doing the majority of their shopping or spending more at the merchant system 104 and determine how to get increased business from the others, or to highlight those loyal consumers. For example, the merchant system 104 may discover that the consumers 106 that go through a specific section of the merchant area 108 may tend to spend more at the merchant system 104 than its competitors, and may then do more to steer other consumers 106 to that specific section or move the specific section to a more heavily trafficked spot of the merchant area 108. Thus, the processing server 102, can provide analytics to merchant systems 104 that are otherwise unavailable thereto, and can do so in a manner that is valuable to the merchant system 104 without sacrificing privacy of consumers 106.

### Processing Server

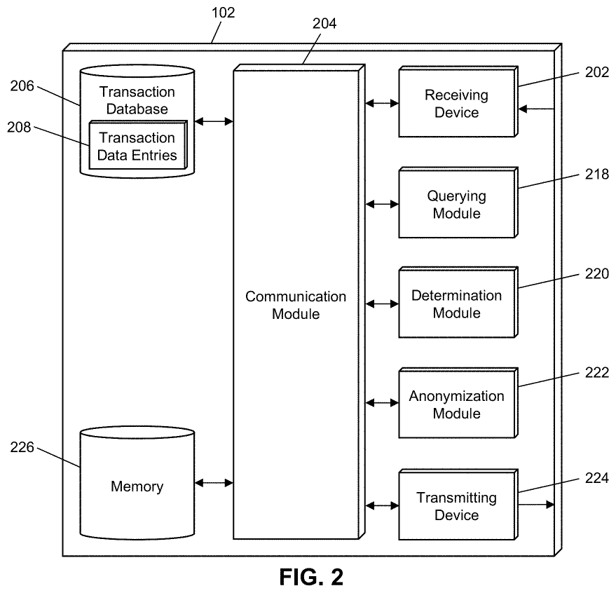

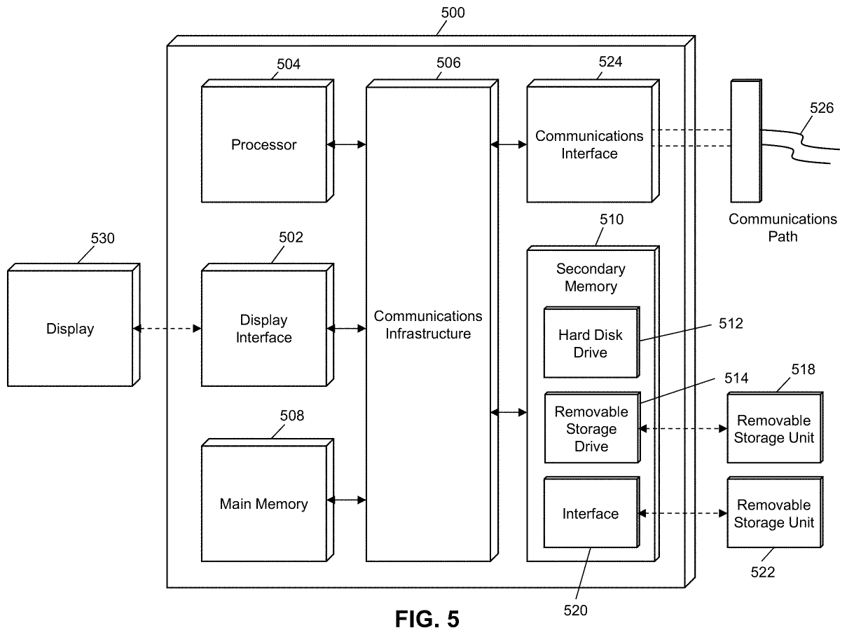

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchant systems 104, point of sale devices 110, payment networks 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchant systems 104 and/or point of sale devices 110 that may be superimposed or otherwise encoded with notifications, which may include at least a timestamp for a payment transaction involving the merchant, and may further include a primary account number, merchant identifier, transaction amount, or other data. The receiving device 202 may also be configured to receive data signals electronically transmitted by merchant systems 104 and/or point of sale devices 110 that may be superimposed or otherwise encoded with IOT data, requested analytics, or other data as discussed herein. The receiving device 202 may also be configured to receive data signals electronically transmitted by payment networks 114 (e.g., using internal network communications, payment rails, etc.), which may be superimposed or otherwise encoded with transaction data for processed payment transactions.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, determination module 220, anonymization module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a transaction database 206. The transaction database 206 may be configured to store a plurality of transaction data entries 208 using a suitable data storage format and schema. The transaction database 206 may be a relational database that utilizes structured query language for the storage, identification, modifying, updating, accessing, etc. of structured data sets stored therein. Each transaction data entry 208 may be a structured data set configured to store data related to a processed payment transaction. A transaction data entry 208 may include, for instance, a transaction time, transaction date, transaction amount, currency type, transaction type, geographic location, merchant identifier, merchant category code, acquirer data, issuer data, primary account number, product data, offer data, reward data, loyalty data, etc. In some cases, a transaction data entry 208 may also include data indicated a microsegment associated with the related payment transaction.

The processing server 102 may include a querying module 218. The querying module 218 may be configured to execute queries on databases to identify information. The querying module 218 may receive one or more data values or query strings, and may execute a query string based thereon on an indicated database, such as the transaction database 206, to identify information stored therein. The querying module 218 may then output the identified information to an appropriate engine or module of the processing server 102 as necessary. The querying module 218 may, for example, execute a query on the transaction database 206 to identify a transaction data entry 208 that is related to a notification received from a point of sale device 110, and then execute a subsequent query on the transaction database 206 to identify a plurality of transaction data entries 208 related to the initially identified transaction data entry 208, such as using microsegments.

The processing server 102 may also include a determination module 220. The determination module 220 may be configured to make to determinations for the processing server 102 as part of the functions of the processing server 102 discussed herein. The determination module 220 may receive an instruction (e.g., requesting a specific determination) as input, may make the requested determination, and may output the result of the determination to another module or engine of the processing server 102. In some cases, the request may include data to be used in the determination. In some instances, the determination module 220 may be configured to identify data to be used in the determination, such as by requesting that the querying module 218 perform a query to identify such data. The determination module 220 may, for example, be configured to determine analytics for enrichment of IOT data based on the transaction data for a plurality of transaction data entries 208.

In some embodiments, the processing server 102 may also include an anonymization module 222. The anonymization module 222 may be configured to anonymize data for the removal or otherwise obscuring of PII in data. The anonymization module 222 may receive data to be anonymized, may anonymize the data, and may output the anonymized data to another module or engine of the processing server 102. As part of the anonymization of data, the non-anonymized data may be discarded by the anonymization module 222. The anonymization module 222 may be configured, for example, to remove PII from received transaction data, such as through the hashing or removal of primary account numbers.

The processing server 102 may also include a transmitting device 224. The transmitting device 224 may be configured to transmit data over one or more networks via one or more network protocols. In some instances, the transmitting device 224 may be configured to transmit data to merchant systems 104, point of sale devices 110, payment networks 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to merchant systems 104 and/or point of sale devices 110 that may be superimposed or otherwise encoded with analytics. In cases where notifications received by the processing server 102 may include a reference identifier or other identifying information, the analytics may be accompanied by such identifying information. The transmitting device 224 may also be configured to electronically transmit data signals to payment networks 114 (e.g., using payment rails associated therewith or other suitable communication methods) that are superimposed or otherwise encoded with requests for transaction data.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, microsegments and data associated therewith (e.g., primary account numbers, demographic characteristics, spending behaviors, etc.), demographic characteristics, analytic models, algorithms for determining analytics, etc.

### Process for Enrichment of IOT Data

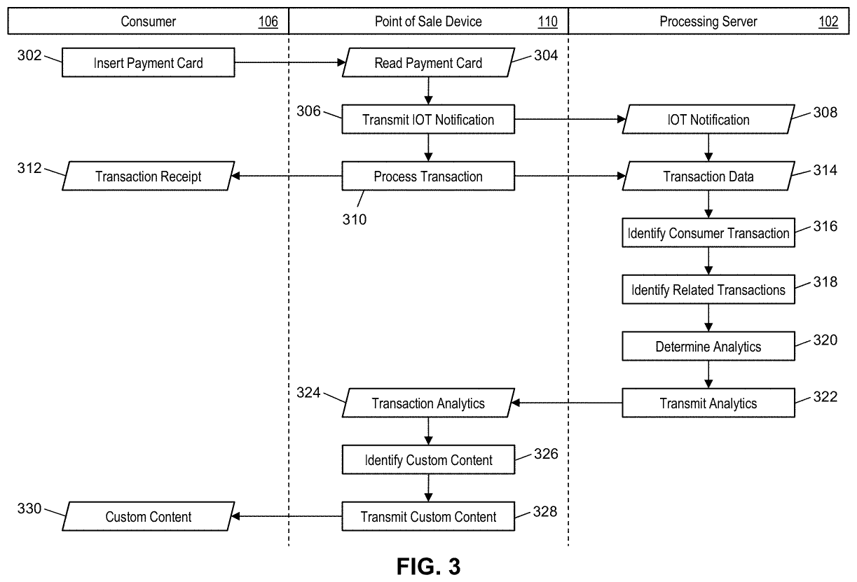

FIG. 3 illustrates an example process for the enrichment of in-store IOT data captured by the merchant system 104 using analytics identified from transaction data by the processing server 102 in the system 100 illustrated in FIG. 1.

In step 302, the consumer 106 may insert their payment instrument 112 into the point of sale device 110 as part of the conducting of a payment transaction involving the merchant system 104. In step 304, the point of sale device 110 may read payment credentials encoded or otherwise stored in the payment card, which may include a primary account number, name, security code, and/or other data. In step 306, the point of sale device 110 may electronically transmit a notification to the processing server 102 for requesting enrichment, which may be transmitted using any suitable communication network and method. In step 308, the receiving device 202 of the processing server 102 may receive the notification. The notification may include at least a time and date captured by the point of sale device 110. In some cases, the notification may further include a device identifier associated with the point of sale device 110, the primary account number read from the payment card, and a transaction amount.

In step 310, the point of sale device 110 may initiate processing of the payment transaction. Processing of the payment transaction may include the submission (e.g., directly by the point of sale device 110 or through one or more intermediate entities, such as an acquiring financial institution) of the transaction data for the payment transaction, including the payment credentials read from the payment card, to the payment network 114. The payment network 114 may then process the payment transaction using traditional methods and systems, which may result in an authorization response or a response based thereon being transmitted back to the point of sale device 110 indicating that the payment transaction was approved. In step 312, the consumer 106 may be furnished a receipt or other indication from the point of sale device 110 that the payment transaction was approved and processed successfully.

In step 314, the receiving device 202 of the processing server 102 may receive the transaction data for the processed payment transaction from the payment network 114 (e.g., or directly from the point of sale device 110 or other entities, as applicable). The received transaction data may be inserted (e.g., via a query executed by the querying module 218 of the processing server 102) into the transaction database 206 of the processing server 102 as a new transaction data entry 208. In step 316, the querying module 218 of the processing server 102 may execute a query on the transaction database 206 to identify the transaction data entry 208 related to the payment transaction involving the consumer 106, which may be identified using fuzzy logic and/or inferred matching, where a match is made based on a matching of the date included in the notification and transaction date in the transaction data entry 208, as well as the time in the notification being within a predetermined period of time of the transaction time in the transaction data entry 208. In cases where the notification includes additional data, such data may also be used in the matching, such as by looking for a match in the primary account number included in the notification and included in the transaction data entry 208.

In step 318, the querying module 218 of the processing server 102 may execute another query on the transaction database 206 to identify a subset of transaction data entries 208 stored therein that are related to the payment transaction involving the consumer 106. Such transaction data entries 208 may be identified as being related through the matching of an additional value included in the transaction data thereof with a value corresponding to the identified transaction data entry 208. The additional value may be, for instance, the primary account number, merchant identifier, IOT identifier (e.g., sensor, motion detector, camera, microphone, and point of sale device 110 identifiers), merchant category code, a microsegment identifier, etc. In step 320, the determination module 220 of the processing server 102 may determine analytics using the transaction data in each of the transaction data entries 208 in the subset. In some cases, the analytics that are identified may be specified in the notification. In other cases, the analytics that are identified may be selected based on the merchant system 104, such as may be provided during a registration process and stored in the memory 226 of the processing server 102.

In step 322, the transmitting device 224 of the processing server 102 may electronically transmit the identified analytics to the point of sale device 110 (e.g., or the merchant system 104, as applicable). In step 324, the point of sale device 110 (e.g., or merchant system 104, as applicable) may identify content customized for the consumer 106 based on the analytics. The custom content may be, for instance, an offer that may entice the consumer 106 to return based on spending behaviors and propensities that may be included in the analytics. For example, the analytics may reveal that the consumer 106 (e.g., based on their microsegment) may have a high propensity to spend on electronics, and so the point of sale device 110 may provide a coupon for electronics to the consumer 106 to use on a later visit. In step 328, the custom content may be transmitted or otherwise distributed to the consumer 106 by the point of sale device 110, and received thereby, in step 330.

### Exemplary Method for Providing Analytics for a Physical Customer

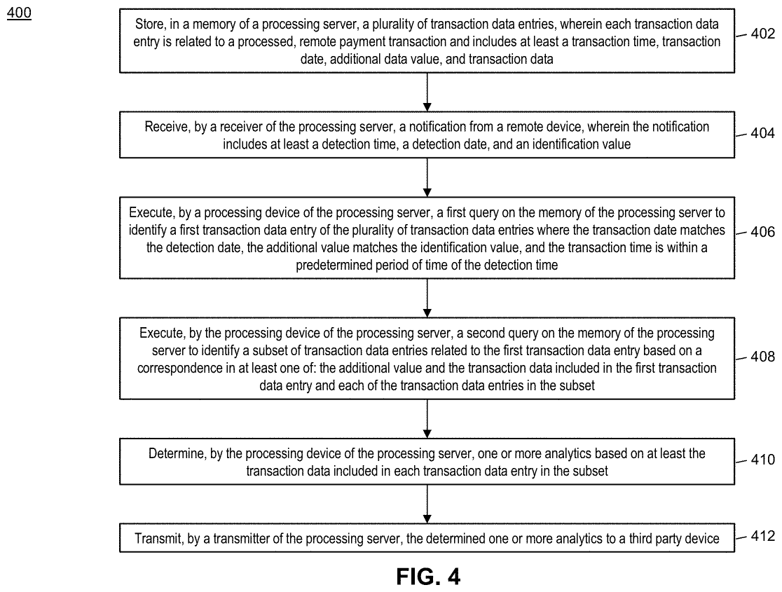

FIG. 4 illustrates a method 400 for the providing of transaction-based analytics for enrichment of internet of things (IOT) data captured for a physical customer.

In step 402, a plurality of transaction data entries (e.g., transaction data entries 208) may be stored in a memory (e.g., the memory 226, transaction database 206, etc.) of a processing server (e.g., the processing server 102), wherein each transaction data entry is related to a processed, remote payment transaction and includes at least a transaction time, transaction date, additional data value, and transaction data. In step 404, a notification may be received by a receiver (e.g., the receiving device 202) of the processing server from a remote device (e.g., the point of sale device 110), wherein the notification includes at least a detection time, a detection date, and an identification value.

In step 406, a first query may be executed by a processing device (e.g., the querying module 218) of the processing server on the memory of the processing server to identify a first transaction data entry of the plurality of transaction data entries where the transaction date matches the detection date, the additional value matches the identification value, and the transaction time is within a predetermined period of time of the detection time. In step 408, a second query may be executed on the memory of the processing server by the processing device (e.g., querying module 218) of the processing server to identify a subset of transaction data entries related to the first transaction data entry based on a correspondence in at least one of: the additional value and the transaction data included in the first transaction data entry and each of the transaction data entries in the subset.

In step 410, one or more analytics may be determined by the processing device (e.g., determination module 220) of the processing server based on at least the transaction data included in each transaction data entry in the subset. In step 412, the determined one or more analytics may be transmitted by a transmitter (e.g., the transmitting device 224) of the processing server to a third party device (e.g., the merchant system 104).

In one embodiment, the additional data value may be a primary account number of a transaction account used to fund the related remote payment transaction. In a further embodiment, a plurality of transaction data entries in the subset may include a different primary account number than the primary account number included in the first transaction data entry. In an even further embodiment, each primary account number included in a transaction data entry in the subset may be associated with one of a plurality of transaction accounts, and each of the plurality of transaction accounts may be associated with a common set of demographic characteristics.

In some embodiments, the additional data value may be a merchant identifier associated with a merchant involved in the related remote payment transaction. In one embodiment, the remote device may be a point of sale device. In a further embodiment, the notification may be transmitted by the point of sale device after insertion of a payment card into the point of sale device. In some embodiments, the remote device may be the third party device.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for providing analytics for a physical customer based on processed remote transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing analytics for a physical customer based on processed remote transactions, comprising:
storing, in a memory of a processing server, a plurality of transaction data entries, wherein each transaction data entry is related to a processed, remote payment transaction and includes at least a transaction time, transaction date, additional data value, and transaction data;
receiving, by a receiver of the processing server, a notification from a remote device, wherein the notification includes at least a detection time, a detection date, and an identification value;
executing, by a processing device of the processing server, a first query on the memory of the processing server to identify a first transaction data entry of the plurality of transaction data entries where the transaction date matches the detection date, the additional value matches the identification value, and the transaction time is within a predetermined period of time of the detection time;
executing, by the processing device of the processing server, a second query on the memory of the processing server to identify a subset of transaction data entries related to the first transaction data entry based on a correspondence in at least one of: the additional value and the transaction data included in the first transaction data entry and each of the transaction data entries in the subset;
determining, by the processing device of the processing server, one or more analytics based on at least the transaction data included in each transaction data entry in the subset; and
transmitting, by a transmitter of the processing server, the determined one or more analytics to a third party device.

2. The method of claim 1, wherein the additional data value is a primary account number of a transaction account used to fund the related remote payment transaction.

3. The method of claim 2, wherein a plurality of transaction data entries in the subset includes a different primary account number than the primary account number included in the first transaction data entry.

4. The method of claim 3, wherein
each primary account number included in a transaction data entry in the subset is associated with one of a plurality of transaction accounts, and
each of the plurality of transaction accounts is associated with a common set of demographic characteristics.

5. The method of claim 1, wherein the additional data value is a merchant identifier associated with a merchant involved in the related remote payment transaction.

6. The method of claim 1, wherein the remote device is a point of sale device.

7. The method of claim 6, wherein the notification is transmitted by the point of sale device after insertion of a payment card into the point of sale device.

8. The method of claim 1, wherein the remote device is the third party device.

9. A system for providing analytics for a physical customer based on processed remote transactions, comprising:
a memory of a processing server configured to store a plurality of transaction data entries, wherein each transaction data entry is related to a processed, remote payment transaction and includes at least a transaction time, transaction date, additional data value, and transaction data;
a receiver of the processing server configured to receive a notification from a remote device, wherein the notification includes at least a detection time, a detection date, and an identification value;
a processing device of the processing server configured to
execute a first query on the memory of the processing server to identify a first transaction data entry of the plurality of transaction data entries where the transaction date matches the detection date, the additional value matches the identification value, and the transaction time is within a predetermined period of time of the detection time,
execute a second query on the memory of the processing server to identify a subset of transaction data entries related to the first transaction data entry based on a correspondence in at least one of: the additional value and the transaction data included in the first transaction data entry and each of the transaction data entries in the subset, and
determine one or more analytics based on at least the transaction data included in each transaction data entry in the subset; and
a transmitter of the processing server configured to transmit the determined one or more analytics to a third party device.

10. The system of claim 9, wherein the additional data value is a primary account number of a transaction account used to fund the related remote payment transaction.

11. The system of claim 10, wherein a plurality of transaction data entries in the subset includes a different primary account number than the primary account number included in the first transaction data entry.

12. The system of claim 11, wherein
each primary account number included in a transaction data entry in the subset is associated with one of a plurality of transaction accounts, and
each of the plurality of transaction accounts is associated with a common set of demographic characteristics.

13. The system of claim 9, wherein the additional data value is a merchant identifier associated with a merchant involved in the related remote payment transaction.

14. The system of claim 9, wherein the remote device is a point of sale device.

15. The system of claim 14, wherein the notification is transmitted by the point of sale device after insertion of a payment card into the point of sale device.

16. The system of claim 9, wherein the remote device is the third party device.
